(19) United States
(12) Patent Application Publication
(10) Pub. No.: US 2008/0035564 A1
(43) Pub. Date: Feb. 14, 2008

(54) Sorbent For Selective Removal Of Contaminants From Fluids

(75) Inventors: Johanna Teresia Moller, Framingham, MA (US); Paul Sylvester, Waltham, MA (US)

Correspondence Address: THOMPSON HINE L.L.P.;Intellectual Property Group, P.O. BOX 8801, DAYTON, OH, 45401-8801, US

(73) Assignee: SOLMETEX, INC., Northborough, MA (US)

(21) Appl. No.: 11/463,330

(22) Filed: Aug. 9, 2006

(51) Int. Cl. C02F 1/42; C25D 1/08

(52) U.S. Cl. 210/638; 205/75

(57) ABSTRACT

Anion exchange materials impregnated with oxygen-containing metal compounds within the exchange matrix as a sorbent, and a method for preparation. The materials remove arsenic and other ligands or contaminants from water and other fluid streams.

### FIELD OF THE INVENTION

A method of manufacture and application of a sorbent for the selective removal of contaminants from fluids.

### BACKGROUND

Sorption processes to remove contaminants from water are operationally simple, require virtually no start-up time, and are forgiving toward fluctuations in feed compositions. A viable and economically competitive sorbent should exhibit high selectivity toward the target contaminant(s), should be durable, and should be amenable to efficient regeneration and reuse. Removing the target contaminant should not cause major changes in pH or in the composition of the influent water.

Sorbents that contain at least one oxygen-containing compound of a metal, such as amorphous and crystalline hydrated iron (Fe) oxide compounds (HFO), may have these qualities. Such sorbents show strong sorption affinity toward both arsenic (III) and arsenic (V) species in solution. HFO particles also show strong sorption affinity towards phosphate, natural organic matter (NOM), selenite, molybdate, vanadate, arsenite, monovalent arsenate, divalent arsenate, phosphate, and other ligands. Other competing ions, such as chloride or sulfate, exhibit poor sorption affinity toward HFO particles.

Traditional synthesis processes of HFO produce only very fine (e.g., micron-sized) HFO particles. Such fine HFO particles are unusable in fixed beds, permeable reactive barriers, or any flow through systems because of excessive pressure drops, poor mechanical strength, and unacceptable durability. To overcome the problem of very fine HFO particles, strong-acid cation exchangers have been modified to contain HFO particles. These supported HFO particles are useful for the removal of arsenic and other contaminants.

Iron loaded cation exchange resins, complexing resins, and alginates have also been tried to remove selenium and arsenic oxyanions. Although cation exchanger loaded HFO particles are capable of removing arsenates or phosphates, their removal capacities are reduced because the cation exchange material is negatively charged because of sulfonic acid or other negatively charged functional groups. The HFO particles dispersed in the cation exchange material are not accessible to dissolved anionic ligands for selective sorption. Consequently, arsenates, phosphates and other oxyanions are rejected due to the Donnan co-ion exclusion effect.

Macroporous cation exchange sorbents with dispersed HFO particles provided arsenic sorption capacity of about 750 μg/g sorbent. Gel-type cation exchange sorbents with dispersed HFO particles provided minimal arsenic sorption capacity; a gel-type cation exchange sorbent loaded with eight percent iron resulted in almost immediate arsenic breakthrough. HFO particles encapsulated with cation exchange sites were not accessible to arsenates or other anionic ligands for selective sorption.

Accordingly, there is a need for a more effective medium and method for selective removal of contaminants from fluid streams, and a method for effectively dispersing HFO particles throughout anion exchange materials.

### SUMMARY

A method to impregnate an anion exchange material with a metal salt where the anion exchange material is contacted with a metal salt in an organic solvent. In one embodiment the organic solvent is an alcohol. Contact occurs under conditions to load the anion exchange material with a metal salt. The metal impregnated anion exchange material is then contacted with a base to precipitate a metal oxide and the metal oxide exchange material is washed and neutralized to remove excess base.

These and other embodiments will be further appreciated with reference to the following figures and examples.

### BRIEF DESCRIPTION OF THE DRAWINGS

FIG. 1 shows arsenic removal using one embodiment of the method.

FIG. 2 shows arsenic breakthrough using a resin prepared by one embodiment of the method.

FIG. 3 shows As(V) uptake results using the resin of FIG. 2.

FIG. 4 shows As(V) uptake results using a resin prepared by one embodiment of the method.

FIG. 5 shows As(V) uptake results using a resin prepared by one embodiment of the method.

FIG. 6 shows As(V) uptake results using two embodiments of resin types prepared by two embodiments of the method.

FIG. 7 shows As(V) breakthrough using a fiber prepared by one embodiment of the method.

### DETAILED DESCRIPTION

Anion exchange materials have positively charged functional groups. Thus, anionic ligands can easily permeate in and out of anion exchange material without encountering the Donnan co-ion exclusion effect. Examples of anionic ligands include, but are not limited to, arsenates, chromates, oxalates, phosphates, and phthalates. Hydrous metal oxide particles, such as hydrous iron oxide (HFO) particles, dispersed or impregnated within an anion exchange material increase anion sorption capacity. Consequently, hydrous metal oxide loaded anion exchange materials exhibit significantly greater capacity for removing arsenates, arsenites, and other arsenic oxyanions, as well as other anionic ligands, in comparison with cation exchange materials. It will be appreciated by one skilled in the art that the terms dispersed, impregnated, or loaded are used synonymously with reference to hydrous metal oxide particles in or on the sorbent except as otherwise indicated. It will be appreciated that the terms resin, material, beads are used synonymously with reference to the anion exchange sorbent and include embodiments such as membranes, fibers, and fibrous material except as otherwise indicated.

Dispersing hydrous metal oxide particles such as HFO particles poses a challenge due to the positively charged functional groups of the anion exchange material and heretofore has not been successfully achieved. As cations, Fe⁺² and Fe⁺³ are repelled by the positively charged functional groups on anion exchange materials, and hence in most circumstances cannot be directly loaded. Thus, methods for dispersing HFO particles within cation exchange materials are not usually applicable when anion exchange materials serve as the sorbent.

An anion exchange material containing dispersed or impregnated metal oxide particles that have been precipitated from a solution into the sorbent is disclosed. The metal oxide particles include, but are not limited to, HFO particles. A fluid containing a ligand, such as an arsenic compound, arsenite, chromate, molybdate, selenite, phosphate, vanadate, or other ligand, is effectively treated using the HFO loaded anion exchange material to reduce or remove the contaminating ligand or compound from the fluid.

The physical properties of the anion exchange material may add structural integrity to materials that are otherwise friable and weak, such as granular ferric oxide (GFO) and granular ferric hydroxide (GFH). Thus, HFO particles dispersed into anion exchange materials can be synthesized with superior material properties when compared to the granulation or agglomeration of HFO particles. The physical robustness of the HFO-loaded sorbent allows for its use under more demanding conditions (i.e. higher operating pressures, increased flow, etc.). It also permits effective regeneration and reuse of the material, reduces the need for backwashing, and reduces other maintenance problems common in the treatment of streams with hydrous metal oxides that are not supported by substrates. Granular inorganic adsorbents are prone to numerous operational problems due to the low physical strength of the particle aggregates. This leads to a gradual breakdown of the aggregates during routine operations resulting in pressure increases, channeling and generally poor hydraulic flow through the sorbent bed.

An anion exchange sorbent containing hydrous metal oxide particles, such as HFO particles, for selective removal of contaminants or other ligands from fluids is prepared by a sequence of steps. In the inventive method, HFO particles are irreversibly encapsulated within and on the surface of the anion exchange material. However, due to the porous nature of anion exchange resin beads, these HFO particles are still accessible to contaminants (e.g. arsenic) within an aqueous stream contacted with the beads. Turbulence and mechanical stirring did not result in any noticeable loss of HFO particles.

The method may be used with both gel-type anion exchange materials (e.g. Purolite A400, Thermax Tulsion A-23P) and macroporous anion exchange materials (e.g. Purolite A503, Thermax Tulsion A-72 MP and with other positively charged substrates including, but not limited to, membranes, filters, fibers and other materials that are appropriately functionalized to contain anion exchange sites or groups. The anion exchange material may be of the Type I or Type II strong base organic resin type that contains quaternary groups with a positively charged nitrogen atom (e.g. Purolite A-510, Rohm & Haas Amberlite PWA900). Alternatively, the anion exchange material may be a weak base organic resin bead containing primary, secondary, and/or tertiary amine groups (e.g. Purolite A100). If the resin is a bead, the bead may be polystyrene, polystyrene/divinylbenzene, polyacrylic, or other polymeric matrices. The anionic exchange material may also be an inorganic material including, but not limited to, hydrous alumina, hydrous zirconia, hydrous titanic, hydrotalcites, and layered double hydroxides (LDH). Various other anionic exchange material may also be used as known to one skilled in the art. For example, polymeric anion exchange beads exhibit excellent kinetics, hydraulic properties, and durability during fixed bed column runs. In all cases, the dispersed hydrous metal oxide particles in or on the beads, fibers, membranes, etc. serve as active sorbents for the contaminants or targeted ligands.

Generally, an anion ion exchange material is contacted for a period of between one and eight hours with a solution of metal salt dissolved in an organic solvent. The resulting metal salt-loaded ion exchange material is collected (e.g., by filtration) and dried at a temperature less than about 150° C. The dried metal-loaded anion exchange material is added to a solution of base (about 1%^{w/v} to about 20%^{w/v}) and stirred for about one hour; the base may be sodium hydroxide, potassium hydroxide, sodium carbonate, sodium bicarbonate, or other alkali. The metal-loaded material is filtered and washed to remove any displaced metal hydroxide and residual base, and is dried at ambient temperature (e.g., about 19° C. to about 25° C. or between about 19° C. up to about 150° C. depending upon the chemical and physical characteristics of the anion exchange material). The process may be repeated many times, for example, to further load hydrous metal oxide-loaded anion exchange material.

The metal loaded on the anion-exchange material is in the form of a hydrous metal oxide or metal hydroxide. The metal may be salts of iron, copper, zinc, nickel, manganese, titanium, zirconium, yttrium, lanthanum (and lanthanides), scandium, yttrium, hafnium, vanadium, niobium, tantalum, chromium, molybdenum, tungsten, manganese, rhenium, ruthenium, osmium, cobalt, rhodium, iridium, palladium, platinum, silver, gold, cadmium, gallium, indium, thallium, germanium, tin, lead, antimony, bismuth, actinium or actinides. In one embodiment, iron salts may be iron (III) sulfate, iron (III) chloride, iron (III) nitrate, iron (III) acetate and/or other soluble iron (III) salts. The organic solvent in which the metal is in solution may be methanol, ethanol, propanol, acetone or other organic solvent in which the metal salt may be soluble.

The method and composition will be further appreciated with respect to the following non-limiting examples.

### EXAMPLE 1

Anion exchange resin (Purolite A500P) (69.2 g in 100 mL) was contacted with 800 mL of 7%^{w/v} FeCl₃ in methanol for six hours and forty minutes to result in iron-loaded resin. The resin was filtered and air dried overnight at ambient temperature. The dried iron-loaded resin was contacted with fresh 7%^{w/v} FeCl₃ in methanol for four hours (second loading). This resin was filtered and air dried at ambient temperature. This dried iron-loaded resin was contacted with fresh 7%^{w/v} FeCl₃ in methanol for four hours (third loading), filtered, and air dried at ambient temperature. This iron-loaded resin was contacted with 0.5%^{w/v} NaOH and stirred for about one hour to precipitate the HFO particles. This solution was filtered and the iron-loaded resin was washed with tap or distilled water, filtered, and dried at ambient temperature. The resulting resin beads were a dark brown/reddish color.

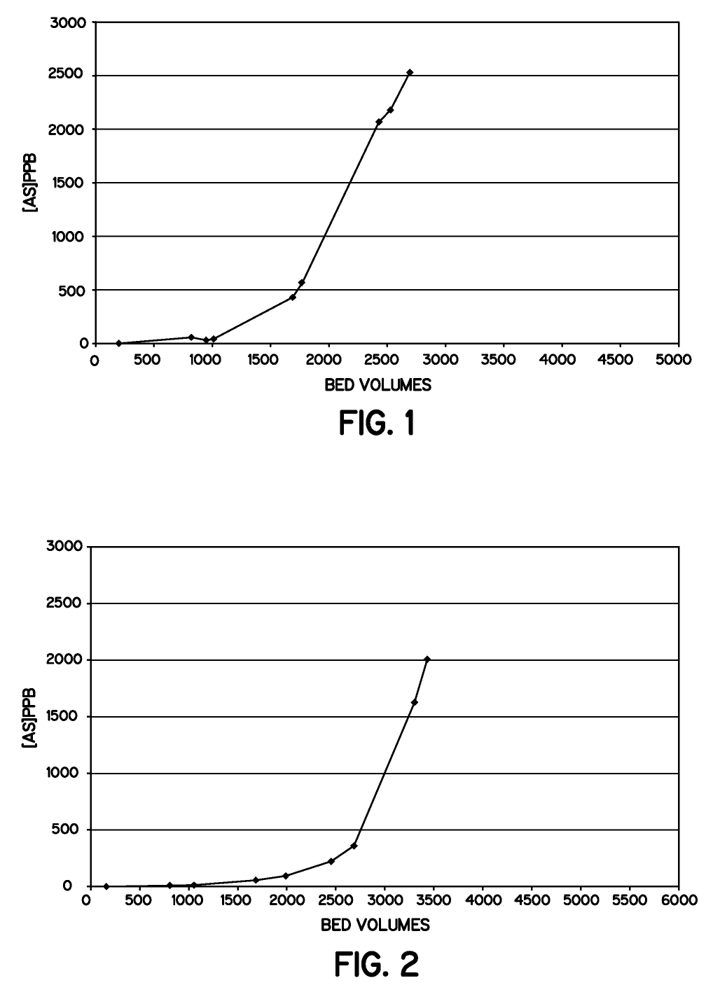

The resulting iron-loaded resin was used to remove arsenic from synthetic water that had been spiked with 3 ppm arsenic (as As(V)). The results are shown in FIG. 1. Synthetic water containing 3 ppm arsenic (as arsenate) at a pH of about 6.5 was passed through an 8 mL bed of the resin with an empty bed contact time (EBCT) of about 90 seconds. The effluent exiting the column was periodically sampled and analyzed for arsenic. As can be seen in FIG. 1, about 2000 bed volumes (BV) of water had been treated before the effluent arsenic concentration reached 1 ppm. In contrast, the parent anion exchange resin unloaded with HFO exhibited almost instantaneous breakthrough (data not shown).

### EXAMPLE 2

Anion exchange resin (34.7 g in 50 mL) (Purolite A400) was contacted with 400 mL of 7%^{w/v} FeCl₃ in methanol for four hours to result in iron-loaded resin. The resin was dried under vacuum and then contacted with about 400 mL of 10%^{w/v} NaOH for about one hour with stirring to precipitate the HFO particles. Any unbound HFO, evidenced as brown iron floc, was decanted. This iron-loaded resin was filtered and rinsed four times with about 400 mL tap or deionized water, and the resulting black resin was vacuum filtered and dried overnight at ambient temperature. The iron-loaded resin was then added to a fresh 7%^{w/v} FeCl₃ in methanol (about 400 mL) and stirred for about 4.5 hours (second loading). This resin was filtered and dried overnight as above, and then contacted with about 400 mL 10%^{w/v} NaOH to precipitate the HFO particles. The residual iron floc was decanted. This solution was stirred for one hour and then washed four times with about 400 mL water. After drying at ambient temperature overnight, this resin was contacted with fresh 7%^{w/v} FeCl₃ methanol (third loading). After stirring for about four hours, this resin was vacuum dried and washed with about 400 mL of 10%^{w/v} NaOH to precipitate the HFO particles. The resin was then filtered and washed four times with about 400 mL water and dried at about 20° C. to about 25° C.

Samples of resin after each FeCl₃ loading cycle were taken and analyzed for iron content (mg of iron per gram of dried resin), as shown in Table 1.

TABLE 1

| FeCl₃ Cycles | Wash | Fe mg/g resin |
|---|---|---|
| Cycle I 7% FeCl₃ | 10% NaOH | 80 |
| Cycle II 7% FeCl₃ | 10% NaOH | 148 |
| Cycle III 7% FeCl₃ | 10% NaOH | 190 |

### Each reaction cycle in 7%^{w/v} FeCl₃ in methanol and 10%^{w/v} NaOH increased the amount of iron immobilized on the resin.

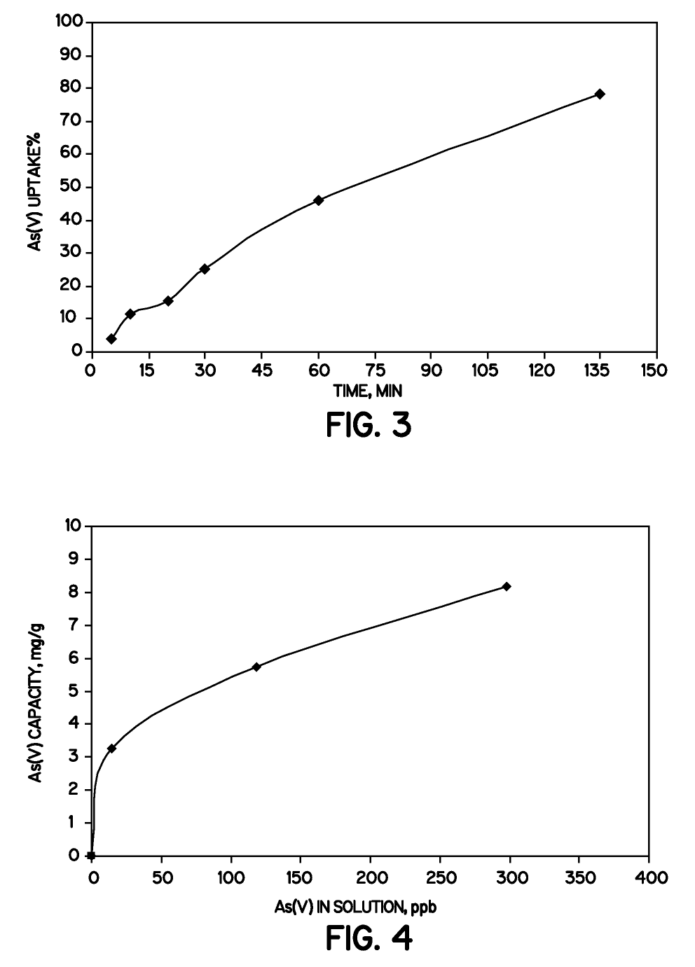

The breakthrough curve for arsenic, using the resin containing about 190 mg iron/g resin (dry weight) after three cycles of iron chloride and sodium hydroxide contact, is shown in FIG. 2. The same water and reaction conditions as described for FIG. 1 were used. Greater than 3000 BVs of water were processed before the arsenic concentration of the effluent reached 1 ppm. The performance of this same resin for percent of As(V) uptake over time is shown in FIG. 3. A 0.1 g sample of the resin was shaken with an aliquot of a solution containing 1 ppm arsenic (as As(V)), 120 ppm sulfate, 33 ppm chloride and 100 ppm bicarbonate for designated times and the arsenic concentration in the solution measured. As can be seen from FIG. 3, some arsenic uptake occurred rapidly, but the amount of arsenic removed continued to increase even after two hours of contact time.

### EXAMPLE 3

A gel-type anion exchange resin (Purolite A400) (34.7 g in 50 mL) was contacted for about four hours with 400 mL 14%^{w/v} FeCl₃ in methanol. The resin was dried under vacuum and contacted with about 400 mL 10%^{w/v} NaOH for about one hour. The resin was filtered and rinsed four times with about 400 mL tap or distilled water. The resulting black resin beads were vacuum filtered and dried overnight at ambient temperature. The iron-loaded resin was added to fresh 14%^{w/v} FeCl₃ in methanol (about 400 mL) (second loading) and stirred for about four hours. The resin was filtered and contacted with about 400 mL of 10%^{w/v} NaOH to precipitate the HFO particles. The iron floc was decanted. The solution was stirred for about one hour, filtered, and washed four times with about 400 mL of water. This iron-loaded resin was filtered and dried at ambient temperature.

Samples of resin after each FeCl₃ loading cycle were taken and analyzed for iron content, as shown in Table 2.

TABLE 2

| FeCl₃ Cycles | Wash | Fe mg/g resin |
|---|---|---|
| Cycle I 14% FeCl₃ | 10% NaOH | 111 |
| Cycle II 14% FeCl₃ | 10% NaOH | 176 |
| Cycle III 14% FeCl₃ | 10% NaOH | 180 |

An isotherm demonstrating the capacity for As(V) for the final product is shown in FIG. 4. In these experiments, different masses of resin were shaken for about eighteen hours with a 1 ppm solution of arsenic(V) in 120 ppm sulfate, 100 ppm bicarbonate, and 33 ppm chloride. The amount of arsenic remaining in solution was then measured and mg of arsenic adsorbed per gram of resin was plotted.

### EXAMPLE 4

A macroporous strong base anion exchange resin (Purolite A500P) (67 g in 100 mL) was stirred in 7%^{w/v} FeCl₃ in methanol for about six hours. The resin turned bright yellow immediately after contact with FeCl₃. Samples of resin were taken for iron analysis after two hours, four hours, and six hours. After six hours, the resin was dried at room temperature (about 20° C. to about 25° C.).

No increase in iron loading was observed after two hours contact with FeCl₃, indicating rapid reaction kinetics. The results are shown in Table 3A.

TABLE 3A

| Time of FeCl₃ Contact | Fe mg/g resin |
|---|---|
| 2 h | 203 |
| 4 h | 197 |
| 6 h | 192 |

Fe-loaded resin from the first FeCl₃ cycle was again contacted with 7%^{w/v} FeCl₃ in methanol for about four hours (second loading), filtered, and dried at room temperature.

This resin was split into two parts: one part was neutralized with 2%^{w/v} NaOH, the other part was neutralized with 10%^{w/v} NaOH. More loose iron floc was formed in the resin treated with 2%^{w/v} NaOH upon washing than in the resin treated with 10%^{w/v} NaOH. This indicated that more iron was lost from the resin when neutralized with 2%^{w/v} NaOH than when neutralized with 10% W/v NaOH.

Both iron-loaded resins were filtered and dried at ambient temperature for about eighteen hours. The resin neutralized with 2%^{w/v} NaOH was reddish-brown, while the resin neutralized with 10%^{w/v} NaOH was darker brown and contained about 25% more iron. The results are shown in Table 3B.

TABLE 3B

| FeCl₃ Cycles | Wash | Fe mg/g resin |
|---|---|---|
| 2nd 7% FeCl₃ contact | 2% NaOH | 119 |
| 2nd 7% FeCl₃ contact | 10% NaOH | 147 |

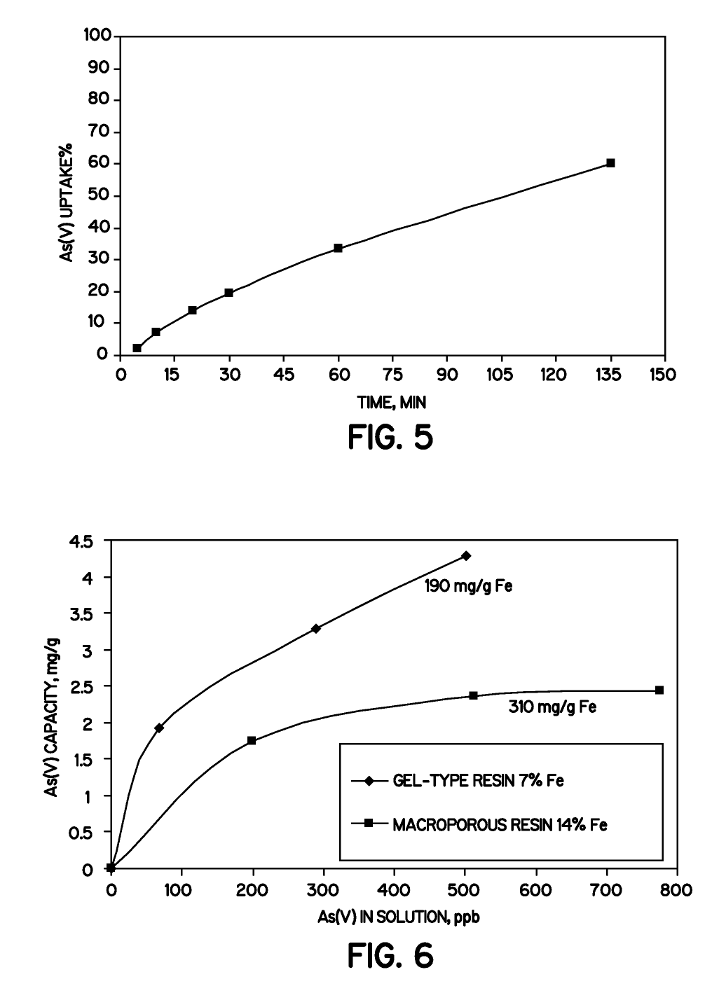

The rate of arsenic uptake of the iron-loaded resin neutralized with 10% NaOH is shown in FIG. 5. As seen previously, arsenic uptake was relatively rapid but continued to increase with time.

### EXAMPLE 5

A macroporous strong base anion exchange resin (Purolite A500P) (33.5 g in 50 mL) was stirred in 400 mL of 14%^{w/v} FeCl₃ in methanol for about four hours. The bright yellow resin beads were filtered from the solution and contacted for about one hour with about 400 mL of 10% W/v NaOH with stirring. The resin beads were filtered and washed four times with about 400 mL of tap or distilled water until the water was clear. The resin beads were vacuum dried using a Buchner funnel and dried at room temperature overnight. The resulting iron-loaded resin beads were a brown-red color. These iron-loaded resin beads were then contacted with fresh 14%^{w/v} FeCl₃ in methanol and stirred for about 4.5 hours (second loading). These resin beads were filtered and contacted with about 400 mL of 10%^{w/v} NaOH to precipitate the HFO particles. The iron floc was decanted. The solution was stirred for about one hour, filtered, and then washed four times with about 400 mL water and dried overnight at room temperature. These resin beads were then contacted with fresh 14%^{w/v} FeCl₃ in methanol (third loading). After stirring for four hours, these resin beads were vacuum dried and contacted with about 400 mL of 10%^{w/v} NaOH to precipitate the HFO particles. These resin beads were washed four times with about 400 mL water and dried at room temperature.

The iron content of the resin beads after each FeCl₃ loading cycle is shown in Table 4.

TABLE 4

| FeCl₃ Cycles | Wash | Fe mg/g resin |
|---|---|---|
| Cycle I 14% FeCl₃ | 10% NaOH | 121 |
| Cycle II 14% FeCl₃ | 10% NaOH | 238 |
| Cycle III 14% FeCl₃ | 10% NaOH | 310 |

### Successive FeCl₃ loading cycles resulted in an increased iron content of the resin.

### EXAMPLE 6

A strong base anion exchange resin (Purolite A500P) (33.5 g in 50 mL) was stirred in 400 mL of 21%^{w/v} FeCl₃ in methanol for about four hours. After filtering the bright yellow resin beads from the solution, the resin beads were contacted with about 400 mL of 10%^{w/v} NaOH to precipitate the HFO particles and stirred for about one hour. The resin beads were filtered and washed four times with about 400 mL of tap or distilled water until the water was clear. These resin beads were vacuumed dried and dried at room temperature (about 19° C. to about 25° C.) overnight. The resulting iron-loaded resin beads were reddish-brown, with an iron content of about 105 mg/g resin (dry weight).

### EXAMPLE 7

Isotherms demonstrating performance capacity for As(V) for the gel type resin loaded with 7% FeCl₃ as prepared in Example 2 and macroporous resin loaded with 14% FeCl₃ as prepared in Example 5, with iron contents of 190 mg/g resin and 310 mg/g resin, respectively, are shown in FIG. 6 As described previously, designated amounts of each resin were shaken for about eighteen hours with an arsenic-containing solution, filtered, and then the aqueous phase was analyzed for arsenic. Arsenic capacities per gram of resin were plotted as shown in FIG. 6. The gel-type resin had a higher equilibrium capacity than the macroporous resin, despite the fact that the iron content of the macroporous resin was greater.

### EXAMPLE 8

Two liters of strong base anion exchange resin (Thermax A-23P) fines (about 150 μm to about 300 μm diameter) were contacted with 16 L of 14%^{w/v} FeCl₃ in methanol for about two hours. Excess methanol was decanted and the resin was allowed to drain to remove any excess fluid. The iron-loaded resin was dried for about thirty minutes in flowing air at room temperature before being added to 16 L of 10%^{w/v} NaOH in deionized water. The mixture was shaken for about one hour, the solution decanted, and the resin washed with tap or distilled water until free from unbound iron floc. This resin was dried at room temperature for about forty-five minutes and contacted with 14%^{w/v} FeCl₃ in methanol for about two hours (second loading). The product was filtered, contacted with 10%^{w/v} NaOH for about one hour to precipitate the HFO particles, washed to remove iron floc and to reduce the pH, and dried. The final product was analyzed with the results shown in Table 5.

TABLE 5

| FeCl₃ Cycles | Wash | Fe mg/g resin |
|---|---|---|
| Cycle I 14% FeCl₃ | 10% NaOH | 174 |
| Cycle II 14% FeCl₃ | 10% NaOH | 270 |

### The final product had an iron content of 270 mg per gram of dry resin

### EXAMPLE 9

Tap water from Northborough, Mass. was spiked with arsenic (as arsenate) to a concentration of about 50 ppb and the pH adjusted to 7.5 with hydrochloric acid. This water was then passed through an 8 mL column of HFO-impregnated gel-type anion exchange resin (Purolite A400) with an empty bed contact time (EBCT) of two minutes. The effluent was then periodically analyzed for arsenic. After 40,000 BVs of water, the arsenic content of the water was still below 10 ppb indicating a high arsenic selectivity.

### EXAMPLE 10

Two different samples of Smopex® synthetic polymer anion exchange fibers (Smoptech, Turku Finland) were impregnated with hydrous iron oxide (14% FeCl₃) and 10%^{w/v} NaOH using the inventive method previously described. Smopex® is the trademark for synthetic fibers for the recovery of metals from waste solutions and solutions from industrial and commercial processing. The characteristics of the fibers are shown in the following table (Table 6).

TABLE 6

| | Capacity | Moisture | | Polymer |
|---|---|---|---|---|
| Identity | meq/g | Content % | Functional group | Backbone |
| Smopex ®-103 | 2 | 7 | Quaternary Amine | Polyolefin |
| Smopex ®-105 | 4 | 14 | Quaternary | Polyolefin |
| | | | Pyridinium | |

### The HFO-impregnated Smopex®-105 fibers settled more rapidly than the HFO-impregnated Smopex®-103 fibers, facilitating separation of the Smopex®-105 fibers from the unbound iron floc.

The Smopex®-103 fibers had 101 mg iron/g dry product. The Smopex®-105 fibers had 217 mg iron/g dry product.

Each of the HFO-impregnated fiber samples described above was evaluated for arsenic removal from synthetic water using a column technique. Synthetic water spiked with 300 ppb arsenic(V) at pH 6.5 was passed through an 8 mL column of the fibers with an empty bed contact time of about 12 seconds. The arsenic concentration in the effluent was measured. The column was stopped at the end of each working day and restarted the following morning.

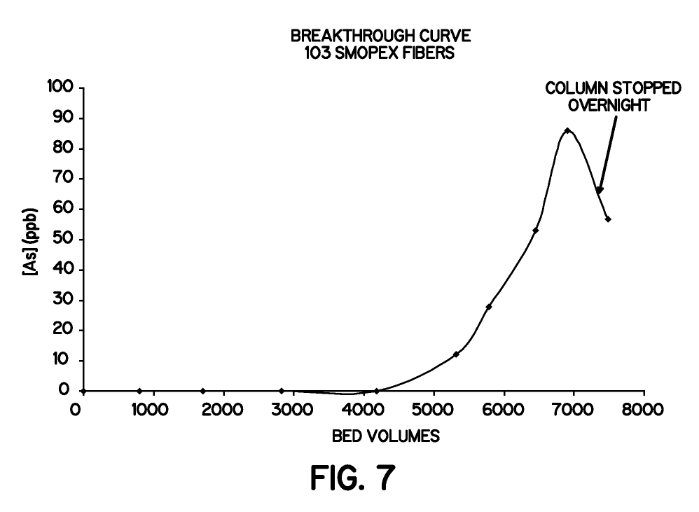

Results are shown in FIG. 7. With HFO-impregnated Smopex®-105 fibers as the sorbent, As(V) breakthrough occurred substantially immediately, with high levels of arsenic present in the effluent in the first sample (not shown). In contrast, with HFO-impregnated Smopex®-103 fibers as the sorbent, As(V) breakthrough exceeding 10 ppb in the effluent did not occur until after more than 4000 bed volumes.

### EXAMPLE 11

Resin beads impregnated with manganese dioxide were prepared. Twenty-five mL of a gel-type strong base anion exchange resin (Dow, SBR-P) was shaken for one hour with 75 mL of a solution of 13% manganese (II) chloride (MnCl₂) in methanol. After one hour, the beads were filtered, dried on a Buchner funnel for fifteen minutes, and then added to 75 mL of a 7.5% solution of sodium hydroxide (NaOH) in deionized water. The mixture was stirred for about thirty minutes, the beads decanted and washed with water to remove any unbound manganese dioxide, and placed on a Buchner flask to remove any surface moisture. The process was repeated to add further MnO₂ to the beads. After completing the second NaOH wash, the manganese dioxide-impregnated beads were washed with water to remove any unbound MnO₂, followed by 200 mL of a 5% sodium chloride solution that had been sparged with carbon dioxide to convert the base resin to the chloride form and remove any residual hydroxide. The final product had a manganese content of 94 mg per gram of dried resin.

### EXAMPLE 12

Beads impregnated with zirconia are prepared. Fifty mL of a gel-type strong base anion exchange resin (Purolite, A400) is shaken for about two hours with 200 mL of a solution of 5% zirconium tetrachloride (ZrCl₄) in ethanol. After two hours, the beads are filtered, dried on a Buchner funnel for fifteen minutes, and then added to 200 mL of a 10% solution of sodium hydroxide (NaOH) in deionized water. The mixture is stirred for thirty minutes, the beads decanted and washed with water to remove any unbound hydrous zirconia (ZrO₂xH₂O) and placed on a Buchner flask to remove any surface moisture. The process is repeated to add further zirconia to the beads. After completion of the second NaOH wash, the zirconia-impregnated beads are placed in a column and 200 mL of a 5% sodium chloride solution is passed through to convert the base resin to the chloride form and remove any residual hydroxide.

Other variations and embodiments of the invention will also be apparent to one of ordinary skill in the art from the above description and examples. Thus, the foregoing embodiments are not to be construed as limiting the scope of this invention.

What is claimed is:

1. A method to impregnate an anion exchange material with a metal, the method comprising
contacting an anion exchange material with a solution of a metal in an organic solvent under conditions to impregnate the anion exchange material with a metal oxide,
contacting the dried metal oxide impregnated anion exchange material with a base for a time sufficient to precipitate a hydrous metal oxide, and
washing and neutralizing the metal oxide impregnated anion exchange material to remove excess base.

2. The method of claim 1 wherein the anion exchange material is organic or inorganic.

3. The method of claim 1 where the metal is an organic solvent soluble salt of at least one of iron, copper, zinc, nickel, manganese, titanium, zirconium, yttrium, lanthanum (and lanthanides), scandium, yttrium, hafnium, vanadium, niobium, tantalum, chromium, molybdenum, tungsten, manganese, rhenium, ruthenium, osmium, cobalt, rhodium, iridium, palladium, platinum, silver, gold, cadmium, gallium, indium, thallium, germanium, tin, lead, antimony, bismuth, actinium, or actinides.

4-5. (canceled)

6. The method of claim 1 wherein the organic solvent is at least one of methanol, ethanol, propanol, or acetone.

7. (canceled)

8. The method of claim 1 wherein a neutralized metal oxide impregnated material is used in the method to provide additional metal oxide impregnation.

9. The method of claim 1 wherein the metal oxide impregnated anion exchange material is dried at a temperature between about 19° C. to about 150° C.

10. The method of claim 1 wherein the base is at least one of sodium hydroxide, potassium hydroxide, sodium carbonate, or sodium bicarbonate.

11. The method of claim 2 wherein an anion exchange material is a Type I or Type II strong base organic ion exchange resin bead containing quaternary ammonium groups with a positively charged nitrogen atom.

12. The method of claim 2 wherein an anion exchange material is a weak base organic ion exchange resin bead containing primary, secondary and/or tertiary amine groups.

13. The method of claim 2 wherein an anion exchange material is at least one of a polymeric matrix or a polymeric fiber.

14. The method of claim 1 wherein an anion exchange material is at least one of a polystyrene matrix, a polystyrene/divinylbenzene matrix, or a polyacrylic matrix.

15. The method of claim 2 wherein an inorganic anion exchange material is at least one of hydrous alumina, hydrous zirconia, hydrous titania, hydrotalcites, or layered double hydroxides (LDH).

16. A method of removing at least one contaminant from a fluid stream, the method comprising contacting at least a portion of a fluid stream with a metal oxide impregnated anion exchange material under conditions sufficient to result in a treated fluid stream with reduced contaminants, the impregnated material prepared by
contacting the anion exchange material with a solution of a metal in an organic solvent under conditions to impregnate the anion exchange material with a metal oxide,
contacting the dried metal oxide impregnated anion exchange material with a base for a time sufficient to precipitate a hydrous metal oxide, and
washing the neutralized metal oxide impregnated anion exchange material to remove excess base.

17. The method of claim 16 wherein the contaminants are selected from at least one of arsenate, arsenite, chromate, molybdate, selenite, phosphate or vanadate.

18. The method of claim 16 where the contaminant is at least one of arsenate As(V), arsenite As(III), vanadate V(V), molybdate Mo(VI), phosphate P(V), chromate or dichromate Cr(VI), selenite Se(IV), or natural organic matter.

19. The method of claim 16 where the fluid is at least one of drinking water, groundwater, industrial process water, organic solvent, mixed solvent systems, or industrial effluents.

20.-27. (canceled)
